(19) United States
(12) Patent Application Publication
(10) Pub. No.: US 2020/0325727 A1
(43) Pub. Date: Oct. 15, 2020

(54) CO-MOLDED SHOE FOR A LADDER RAIL AND METHOD FOR FORMING SUCH SHOE

(71) Applicant: Louisville Ladder Inc., Louisville, KY (US)

(72) Inventor: Andrès Eduardo REYES ACOSTA, San Nicolas de los Garza (MX)

(21) Appl. No.: 16/832,709

(22) Filed: Mar. 27, 2020

Related U.S. Application Data
(60) Provisional application No. 62/832,584, filed on Apr. 11, 2019.

(51) Int. Cl. E06C 7/46; B29C 45/14

(52) U.S. Cl. CPC E06C 7/46; B29L 2031/745; B29C 45/14336

(57) ABSTRACT

A shoe for a rail of the ladder has a body with a bottom and a pair of sides in parallel relation to each other, and a tread co-molded to the bottom of the body. The bottom of the body can either be flat or generally U-shaped. The tread has a plurality of ribs formed on a surface thereof opposite the bottom of the body. The body is formed of a metallic material and the tread is formed of a polymeric material.

### RELATED U.S. APPLICATIONS

The present application claims priority from U.S. Provisional Patent Application Ser. No. 62/832,584, filed Apr. 11, 2019 and entitled “Co-Molded Shoe for a Ladder Rail and Method for Forming Such Shoe”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

### 1. Field of the Invention

The present invention relates to shoes as used with ladders. More particularly, the present invention relates to treads that are affixed to the bottom of the shoe. More particularly, the present invention the relates to polymeric treads that are co-molded to the bottom of a body of the shoe.

### 2. Description of Related Art Including Information Disclosed Under 37 CFR 1.97 and 37 CFR 1.98

Many different types of ladders exist and are being used for accessing relatively high otherwise out-of-reach areas. Ladders of all sorts such as stepping stools, extension ladders, portable ladders, shop ladders, among others, are now being used in many different residential, industrial and commercial applications around the world for various purposes.

The American National Standards Institute (ANSI) has set certain safety standards for ladders. More specifically, ANSI promotes and publishes voluntary consensus standards and safe use guidelines for many products, including ladders. In the case of ladders, ANSI standards provide detail specification of the various materials, construction requirements, test requirements, usage guidelines, and labeling/marking requirements for ladders. For example, ANSI has set forth certain skid resistance requirements for ladders in an effort to reduce the likelihood of ladders skidding or slipping across the surfaces upon which they are being used. Consequently, ANSI standards are an important consideration whenever a ladder is being designed or manufactured.

Another important design criteria for ladders is longevity and their resistance to damage. Thus, ladders are typically made of hard materials which tend to prolong their useful life. However, because hard materials are often associated with relatively low coefficients of friction, ladder rails have, in the past, failed to comply with ANSI skid resistance requirements. To allow for an ANSI-compliant ladder rail, among other reasons, the end of the ladder rail is usually covered with either a ladder boot or a ladder shoe, either of which provides increased skid resistance for the ladder rail.

Although current ladder boots and ladder shoes are both able to increase a ladder rail's skid resistance, they are not without their drawbacks. For example, existing ladder boots are made from a single material, which is usually a soft material, such as polyvinyl chloride, having a relatively high coefficient of friction associated therewith. Unfortunately, soft materials are more susceptible to wear and tear such that ladder boots made therefrom have relatively short useful lives. A ladder boot made of a soft material can be worn down in a short period of time since the ladder boot is frequently dragged along the floor when the ladder is being moved. Once the ladder boot is sufficiently worn, the ladder boot should be timely replaced. The frequent replacement of ladder boots, unfortunately, involves a significant amount of lost time and subsequent costs. As such, a need has developed whereby the ladder boot is substantially strong and has a tread which would not require frequent replacement or repair.

Another problem associated with prior art ladder boots is the susceptibility for marring an underlying surface. The bottom of the ladder boot or shoe (these terms being synonymous) can cause marring on an underlying surface during use. As such, a need has developed so as to provide a ladder boot or shoe which reduces the possibility for marring an underlying surface.

Another problem associated with the tread as used with ladder boots or shoes is the time and effort required to properly fasten the tread to the bottom of the boot or shoe. In particular, openings are required to be formed in both the bottom of the ladder shoe and in the tread. Ultimately, fasteners will need to be inserted through these holes and secured to the shoe and the tread in order to properly fix the tread to the bottom of the shoe. This involves a complicated manufacturing processes. As result, the cost and effort required to produce such a shoe can be needlessly expensive.

FIGS. 1 and 2 show one type of prior art ladder shoe. It can be seen in FIG. 1 that the ladder shoe 10 has a body 12 and a tread 14 secured by fasteners 16, 18 and 20 to the bottom of the body 12. The tread 14 has a plurality of ribs 22 that are arranged so as to extend outwardly of the tread 14 away from the body 12. The fasteners 16, 18 and 20 are introduced into those areas between the tread. If any of the fasteners 16, 18 and 20 should protrude a distance outwardly of the ribs 22, a significant amount of marring to an underlying surface can occur. The ends 24 and 26 of the tread 14 are received in slots 28 and 30 located at the bottom of each of the sides 32 and 34 of the shoe 10.

FIG. 2 shows the shoe 10 from a different perspective in which it can be seen that the fastener 20 is in the nature of a rivet which has an end extending through the hole in the bottom of the body 12. The head of the fastener 20 has a tendency to extend outwardly beyond the rib 22 when pressure is applied to the tread 14, such as by a person standing on the ladder to which the shoe 12 is secured.

FIG. 3 is a perspective view of an alternative embodiment of a prior art shoe 40. As can be seen, shoe 40 has a pair of sides 42 and 44 which extend upwardly from a bottom 46 in generally parallel relationship to each other. Sides 42 and 44 will be secured to the sides of a ladder rail in a conventional manner. The tread 48 is secured to the bottom 46 of the body 50 through the use of fasteners 52 and 54. The tread 48 extends downwardly from the body 50 and will include ribs 56 that are designed to contact an underlying surface in a non-slidable manner.

Once again, in connection with the prior art shown in FIG. 3, the tread 48 is secured to the body 50 through the use of fasteners 52 and 54. If the head of the fastener should extend outwardly below the bottom of the rib 56, it can cause a marring to an underlying surface. Furthermore, the efforts that are required to secure the tread 48 to the bottom 46 of the body 50 can be extensive and can add significant costs to the manufacturing process. If any of the fasteners 52 or 54 should become loose, then the tread 48 could separate from the bottom 46 of the body 50.

In the past, various patents have issued relating to the design of shoes for use in association with ladder rails. For example, U.S. Pat. No. 1,973,226, issued on Sep. 11, 1934 to Rose et al., describes an anti-slipping shoe for ladders. The anti-slipping shoe has apertured sides fitted in the recesses of the ladder rails and flush with the sides of the ladder rails. Bolts are provided in the apertures of the shoes and the side rails. An edge of the recess provides a shoulder upon which the ladder shoe abuts.

U.S. Pat. No. 2,992,696, issued on Jul. 18, 1961 to M. Jedinak, teaches an anti-skid shoe for a ladder. This anti-skid shoe is for permanent attachment to the rail ends of a ladder. The ladder shoe comprises a flat metal plate and a means for mounting the plate to the side surface of the ladder rail adjacent to one of its ends. A pair of right angle flange members are formed integrally on one side of the plate and project substantially perpendicularly outwardly therefrom to extend around and embrace the opposed adjoining longitudinal and transverse edge portions of the ladder rail end. A continuous pad of a rubber-like material is bonded to the surface of each of the flange members remote from the edge portions and has a curved surface substantially parabolic in configuration and positioned to frictionally engage a supporting surface for the rail and to prevent slippage of the ladder.

U.S. Pat. No. 4,694,932, issued on Sep. 22, 1987 to T. J. Schmidt, provides a structural support shoe wherein rigid angular parts have base members positioned and in cooperative reinforcing relation and joined together with the side members extending in opposed faced and spaced relation to each in order to form the structural shoe.

U.S. Pat. No. 5,154,255, issued on Oct. 13, 1992 to Kiska et al., provides a ladder shoe for providing enhanced stability between the ladder and a variety of surfaces. The ladder shoe is comprised of a shoe body having a first side plate, a second side plate and a base. The first side plate and the second side plate are attached to the base. The side plates include curved slots through which a fastener is disposed which movably connects the ladder shoe to the end of the ladder's side rail, thereby allowing the ladder shoe to move between a first position where the base is at a first angle with respect to the side rail and a second position where the base is at a second angle with respect to the side rail. Each slot has a notch in which the fastener catches causing the shoe to be maintained in an intermediate position until the shoe body is desired to be placed into another position. The base has a bottom which provides a slip-resistant surface for engaging the shoe body to essentially flat surfaces when the shoe body is in the first position.

U.S. Pat. No. 5,370,203, issued on Dec. 6, 1994 to S. K. Kiska, provides a ladder shoe spur plate. The ladder shoe has a base that comprises an elongate portion having a first side and a second side, a first edge and a second edge, a top face and a bottom face. The top face is attached to the ladder rail attachment portion. The base also includes a footpad. First and second flanges are disposed such that they retain the footpad along the bottom surface.

U.S. Pat. No. 7,000,731, issued on Feb. 21, 2006 to the present Applicant, provides a multi-material cover for a ladder rail end. This cover for an end of a ladder rail includes a shell and a tread. The shell comprises at least one material, whereas the tread comprises at least one other material. The shell is sized to engage the ladder rail. The tread is engaged with the shell at least partially by at least one bond, which comprises at least a portion of the shell and at least a portion of the tread.

U.S. Pat. No. 10,017,989, issued on Jul. 10, 2018 to S. Kellogg, teaches an anti-slip ladder shoe adapter. This adapter is configured to be removably affixed to an existing shoe of a ladder to provide friction on icy and other surfaces exhibiting similar friction coefficients. Each adapter is provided with a serrated bottom surface in the first embodiment or a spiked bottom surface in a second embodiment in order to provide superior traction.

U.S. Patent Application Publication No. 2004/0020582, published on Feb. 5, 2004 to the present Applicant, discloses a method for making a cover for an end of a ladder rail. The method comprises the steps of using at least one material to make a shell, using at least one other material to make a tread, and bonding at least a portion of the tread with at least a portion of the shell. The shell and the tread are bonded to one another during the manufacturing process such that the shell and the tread are not be mechanically fastened to one another.

It is an object of the present invention to provide a ladder shoe which provides stability to a ladder on an underlying surface.

It is object of the present invention to provide a ladder shoe which does not require mechanical attachments.

It is another object of the present invention to provide a ladder shoe in which the tread is co-molded with a body of the shoe.

It is another object of the present invention to provide a ladder shoe which minimizes the cost and effort required to manufacture the ladder shoe.

It is still a further object of the present invention to provide a ladder shoe which is relatively easy to use, easy to manufacture and relatively inexpensive.

These and other objects and advantages of the present invention will become apparent from a reading of the attached specification and appended claims.

### BRIEF SUMMARY OF THE INVENTION

The present invention is a shoe for a ladder rail comprising a body having a bottom and a pair of side panels in parallel relation to each other, and a tread co-molded to the bottom of the body.

In one embodiment of the present invention, the body has a generally U-shaped configuration. The bottom is curved and extends between the pair of side panels. The tread conforms to a curvature of the bottom of the body. The bottom of the body has a plurality of slots formed therein. The tread is co-molded such that material of the tread extends into the plurality of slots. The plurality of slots each have a generally T-shaped configuration with the bottom of the T-shaped configuration opening at the bottom of the body. The plurality of slots are generally evenly spaced from each other at the bottom of the body.

In an alternative embodiment, the bottom of the body has a smooth curved and uninterrupted surface. The bottom has a first slot formed inwardly adjacent to one of the pair of side panels and a second slot formed inwardly adjacent to another of the pair of side panels. The tread has portions filling the first and second slots.

In the present invention, the tread has a plurality of ribs formed on a side thereof opposite the bottom of the body. Each of the plurality of ribs extends across a width of the tread. The tread is affixed to the bottom of the body without fasteners.

In another embodiment of the present invention, the bottom of the body is flat. The plurality of sides extend upwardly from opposite sides of the bottom of the body. The tread has an upper flat surface co-molded to the bottom of the body. The bottom of the body has a channel formed therein. The tread is received in this channel. The channel is defined by flanges extending outwardly from opposite sides of the bottom of the body. The tread has a plurality of ribs formed on a surface thereof opposite the bottom of the body. The plurality of ribs are evenly spaced from each other and extend transverse to a longitudinal axis of the tread. The bottom of the body can also have a plurality of channels formed therein. The tread has material extending into the channel. In each of the embodiments of the present invention, the body is formed of a metallic material and the tread is formed of a polymeric material.

The present invention is also a method for forming a shoe for a rail of the ladder. This method includes the steps of: (1) forming a body having a pair of sides extending in parallel relation to each other and a bottom located at a bottom of the pair of sides; (2) placing the body into a mold; (3) flowing a polymeric material into the mold; and (4) pressurizing the polymeric material in the mold so as to co-mold the polymeric material onto the bottom of the body so as to form a tread that is secured to the bottom of the body without fasteners.

In this method, the step of forming includes forming slots in the body at or adjacent to the bottom of the body. The step of pressurizing includes flowing the pressurized polymeric material into the formed slots. The mold has channels formed in a wall thereof. The step of pressurizing further includes flowing the polymeric material under pressure into the channel so as to form ribs at the bottom of the tread. Following the forming of the shoe, the method of the present invention includes removing the body with the co-molded tread affixed thereto from the mold.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a bottom perspective view of a ladder shoe of one embodiment of the prior art.

FIG. 2 is an upper perspective view of the ladder shoe of the prior art of FIG. 1.

FIG. 3 is a perspective view of an alternative embodiment of the ladder shoe of the prior art.

FIG. 4 is a side elevational view of a ladder shoe in accordance with a first embodiment of the present invention.

FIG. 5 is a perspective view of a ladder shoe in accordance with a second embodiment of the present invention.

FIG. 6 is a perspective view of a third embodiment of the ladder shoe of the present invention.

### DETAILED DESCRIPTION OF THE INVENTION

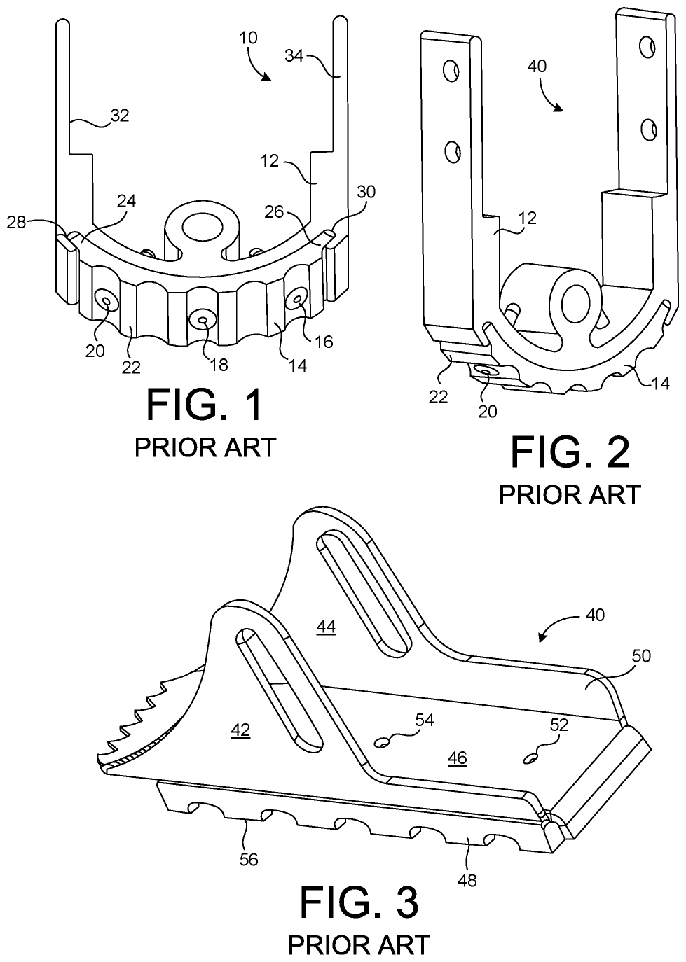

Referring to FIG. 1, there is shown the ladder shoe 70 in accordance with a first embodiment the present invention. The ladder shoe 70 includes a body 72 having a pair of side panels 74 and 76. Side panels 74 and 76 extend in parallel relation to each other. The body 72 also has a bottom 78 that extends between the pair of side panels 74 and 76. A tread 78 is affixed to the bottom 78 of the body 72.

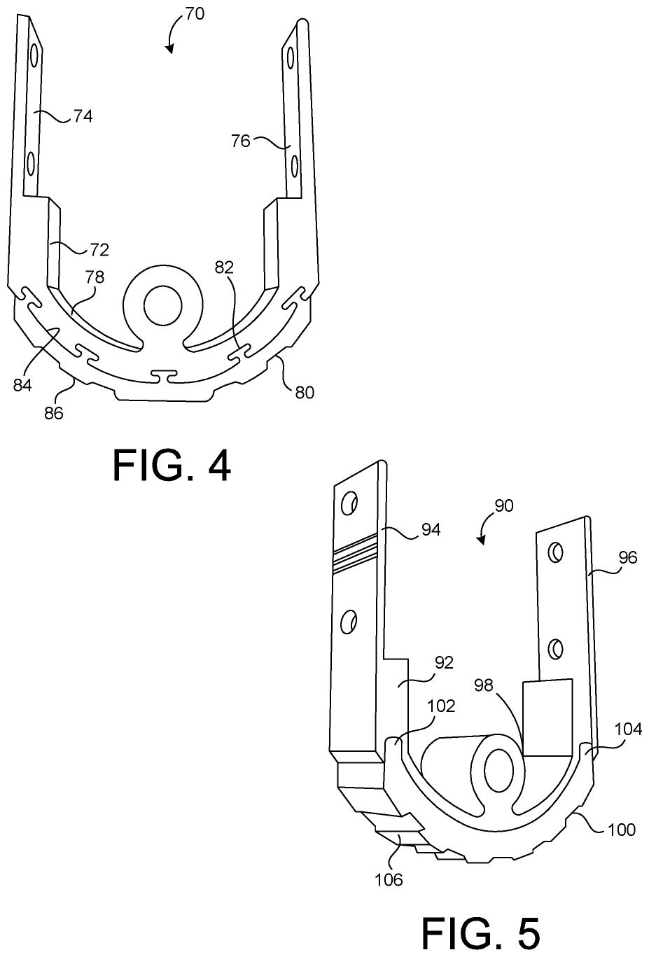

In the first embodiment shown in FIG. 4, the body 72 has a generally U-shaped configuration. The bottom 78 is curved and extends between the pair of side panels 74 and 76. The tread 80 has a curvature conforming to a curvature of the bottom 78. The bottom 78 of the body 72 has a plurality of slots 82 formed therein. The tread is co-molded such that the material of the tread extends into the plurality of slots 82. In this embodiment of the present invention, the plurality of slots 82 each have a generally T-shaped configuration such that a bottom of the T-shaped configuration opens to the bottom surface 84 of the bottom 78 of the body 72. The plurality of slots 82 are generally evenly spaced from each other at the bottom 78 of the body 72.

The tread 80 has a plurality of ribs 86 formed on a surface thereof opposite to the bottom 78 of the body 72. Each of the plurality of ribs 86 extends across a width of the tread 80. It can be seen that the tread 80 is affixed to the bottom 78 of the body 72 without fasteners. In the present invention, the body 72 is formed of a metallic material and the tread 80 is formed of a polymeric material.

FIG. 5 shows an alternative embodiment of the ladder shoe 90 in accordance with the present invention. As with the previous embodiment, the ladder shoe 90 includes a body 92 having side panels 94 and 96 extending in parallel relation to each other. The body 92 also has a bottom 98 extending between the pair of side panels 94 and 96. A tread 100 is affixed to the bottom 98 of the body 92.

It can be seen in FIG. 5 that the bottom 98 of the ladder shoe 90 has a smooth curved and uninterrupted surface. A first slot 102 is formed inwardly adjacent to the side panel 94 and a second slot 104 formed at a bottom of the second side panel 96. The tread 100 has portion filling each of the slots 102 and 104. Once again, the tread 100 is co-molded to the bottom 98 of the body 92. The tread 100 has a plurality of ribs 106 formed of a surface thereof opposite to the bottom 98 of the body 92. Each of the plurality of ribs 106 extends across a width of the tread 100. Once again, the tread 100 is affixed to the bottom 98 without fasteners.

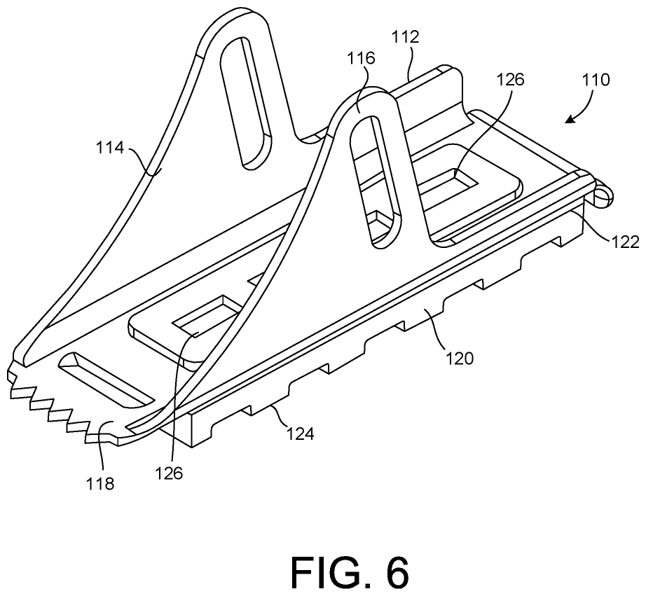

FIG. 6 is shows a further embodiment of the ladder shoe 110 of the present invention. The ladder shoe 110 includes a body 112 having a pair of side panels 114 and 116 that extend in parallel relationship to each other. The body 112 includes a bottom 118 that extends between the pair of side panels 114 and 116. The bottom 118 is flat. The pair of side panels 114 and 116 extend upwardly from opposite sides of the bottom 118. The tread 120 has an upper flat surface affixed to the bottom 118 of the body 112.

In FIG. 6, it can be seen that the bottom 118 has a channel 122 formed therein. The tread 120 is received within the channel. This channel 122 is defined by flanges extending outwardly from opposite sides of the bottom 118 of the body 112. The tread 120 has a plurality of ribs 124 formed on a surface thereof opposite to the bottom 118 of the body 112. The plurality of ribs 124 are evenly spaced from each other and extend transverse to a longitudinal axis of the tread 120. The bottom 118 also includes a plurality of channels 126 that open at the bottom of the body 112. The tread has material extending into these channels 126. Once again, the body 112 is formed of a metallic material and the tread 120 is formed of a polymeric material.

The process of the present invention, for each of the above-stated embodiments, includes forming the body, placing the body into a mold, flowing a polymeric material (as used for the tread) into the mold, and pressurizing the polymeric material in the mold so as to co-mold the polymeric material onto the bottom of the body so as to form a tread that is secured to the bottom of the body without fasteners. Slots can be formed in the body of the bottom of the body and then the pressurized polymer is flowed into these formed slots. The mold can have channels formed in the wall thereof. The polymeric material is flowed into the mold under pressure and into the channel so as to form ribs at the bottom of the tread. Following the formation of the shoe, the shoe is removed, with the tread affixed thereto, from the mold.

In the present invention, the tread is secured to the shoe without fasteners. This eliminates the extensive processes used in the mechanical fastening of the shoe to the body. The co-molding of the tread to the body assures that the tread is strongly secured to the shoe. Furthermore, the co-molding of the tread to the body without the use of fasteners avoids the possibility of the fasteners extending beyond the ribs of the tread and ultimately causing a marring of an underlying surface. The process of the present invention greatly reduces the costs associated with the manufacturing of the shoe and greatly expedites the manufacturing of the shoe. Additionally, the aesthetic appearance of the shoe is improved since mechanical fasteners are not exposed at the tread of the shoe.

The foregoing disclosure and description of the invention is illustrative and explanatory thereof. Various changes in the details of the illustrated construction or in the steps of the described method can be made is the scope of the present invention without departing from the true spirit of the invention. The present invention should only be limited by the following claims and their legal equivalents.

I claim:

1. A shoe for a ladder rail, the shoe comprising:
a body having a pair of side panels in parallel relation to each other and a bottom; and
a tread co-molded to the bottom of said body.

2. The shoe of claim 1, said body having a generally U-shaped configuration, the bottom being curved and extending between said the pair of side panels, said tread conforming to a curvature of the bottom.

3. The shoe of claim 2, the bottom of said body having a plurality of slots formed therein, said tread being co-molded such that material of said tread extends into the plurality of slots.

4. The shoe of claim 3, said plurality of slots each having a generally T-shaped configuration with a bottom of the T-shaped configuration opening at the bottom of said body.

5. The shoe of claim 4, said plurality of slots being generally evenly spaced from each other at the bottom of said body.

6. The shoe of claim 2, the bottom of said body having a smooth curved and uninterrupted surface, the bottom having a first slot formed inwardly adjacent to one of said pair of side panels and a second slot formed inwardly adjacent to another of said pair of side panels, said tread having portions filling the first and second slots.

7. The shoe of claim 1, said tread having a plurality of ribs formed on a surface thereof opposite the bottom of said body.

8. The shoe of claim 7, each of said plurality of ribs extending across a width of said tread.

9. The shoe of claim 1, said tread being affixed to the bottom of said body without fasteners.

10. The shoe of claim 1, the bottom of said body being flat, said pair of sides extending upwardly from opposite sides of said bottom, said tread having an upper flat surface molded to the bottom of said body.

11. The shoe of claim 10, the bottom of said body having a channel formed therein, said tread being received in said channel.

12. The shoe of claim 11, said channel being defined by flanges extending downwardly from opposite sides of the bottom of said body.

13. The shoe of claim 10, said tread having a plurality of ribs formed on a surface thereof opposite the bottom of said body.

14. The shoe of claim 13, said plurality of ribs being evenly spaced from each other and extending transverse to a longitudinal axis of said tread.

15. The shoe of claim 10, the bottom of said body having a plurality of channels formed therein, said tread having material extending into the channels.

16. The shoe claim 1, said body being of a metallic material, said tread being of a polymeric material.

17. A method for forming a shoe for a rail of a ladder, the method comprising:
forming a body having a pair of sides extending in parallel relation to each other and a bottom extending between the pair of sides;
placing the body into a mold;
flowing a polymeric material into the mold; and
pressurizing the polymeric material in the mold so as to co-mold the polymeric material onto the bottom of the body so as to form a tread that is secured to the bottom of the body without fasteners.

18. The method of claim 17, the step of forming comprising:
forming slots of the body at or adjacent to the bottom of the body, the step of pressurizing comprising:
flowing the pressurized polymeric material into the formed slots.

19. The method of claim 17, the mold having channels formed on a wall thereof, the step of pressurizing comprising:
flowing the polymeric material under pressure into the channel so as to form ribs at the bottom of the tread.

20. The method of claim 17, further comprising:
removing the body with the tread affixed thereto from the mold.
